(19) United States
(12) Patent Application Publication
(10) Pub. No.: US 2012/0217307 A1
(43) Pub. Date: Aug. 30, 2012

(54) RFID TAG ASSEMBLY AND METHOD

(75) Inventors: Philippe Martin, Beaune (FR); David Malcolm Hall, Lockleys (AU)

(73) Assignee: TAGSYS SAS, La Penne-Sur Huveaune (FR)

(21) Appl. No.: 13/262,464

(22) PCT Filed: Apr. 1, 2010
(86) PCT No.: PCT/AU10/00373

§ 371 Date: May 9, 2012

(30) Foreign Application Priority Data
Apr. 3, 2009 (AU) 2009901450

(51) Int. Cl. G06K 19/077; H01Q 1/12

(52) U.S. Cl. 235/492; 29/601

(57) ABSTRACT

A method is disclosed of producing an RFID tag assembly including an associated antenna and attachment means suitable for attaching the tag assembly to a material. The material may be flexible such as fabric or relatively rigid such as cardboard. The method includes forming the associated antenna and the attachment means as a unitary conductive frame. An RFID tag assembly produced by the method is also disclosed.

### BACKGROUND OF THE INVENTION

The present invention relates to an RFID tag assembly and method for producing the tag assembly. The tag assembly includes an associated antenna and an attachment means for attaching the assembly to a material. The material may be flexible such as fabric or it may relatively rigid such as cardboard. In a preferred embodiment the invention may include a rivet containing a radio frequency identification (RFID) tag. In some embodiments the tag may be applied to the material in the vicinity of a structure present on the material which structure may function as a secondary antenna.

### THE PRIOR ART

Use of a generic RFID tag on material such as fabric typically involves stitching the tag directly to the fabric or enclosing it within a patch to provide an enclosure for the tag. However this often leads to a bulky and inflexible solution particularly with a clothing garment that may be uncomfortable to wear.

In one prior art solution, a conductive thread is used to provide a secondary antenna and a plastic encapsulated RFID tag in the form of a traditional clothing button is stitched to the fabric in order to couple to the secondary antenna to form a larger overall tag system. While this solution is flexible and comfortable the thread link holding the button to the fabric loosens over time with repeated washing cycles and the button can rock about or tilt, deteriorating electromagnetic coupling between a primary antenna on the RFID tag and the secondary antenna associated the fabric.

An object of the present invention is to at least alleviate the disadvantages of the prior art.

### SUMMARY OF THE INVENTION

The present invention may provide a two part tag solution, namely an RFID tag assembly including an associated or primary antenna formed with means for attaching the assembly to a material such as fabric or cardboard. In some embodiments the primary antenna may couple to a secondary antenna provided on or with the material. This solution may be particularly useful since use of ultra high frequency (UHF) as a carrier frequency for RFID tags has become more widespread following introduction of international UHF RFID standards. Although RFID protocols have converged, allowed regional UHF carrier frequencies have not. A separate secondary antenna may be useful for longer range operation because it may allow itself and thus the overall tag be optimised for an operating region, using a common and economically manufacturable generic tag which may account for most of the total cost.

The present invention may address the problems of the prior art by providing an RFID assembly such as a rivet to replace the unstable button. The rivet may be held firmly in place to maintain a relatively consistent electromagnetic coupling between the primary antenna associated with RFID tag and a secondary antenna associated with a flexible material such as a fabric item. The coupling may be substantially maintained throughout many washing cycles of the service life of the fabric item.

The body of the rivet may be constructed from plastics such as polyamide (e.g. Nylon), a fluoropolymer (e.g. polytetrafluoroethylene (PTFE) or Teflon), a urethane, or acrylonitrile butadiene styrene (ABS), all which may exhibit desirable working properties such as molding or machining and may be relatively soft for comfortable wearing on a clothing garment.

The RFID assembly may include a rivet and an RFID tag including a primary antenna. The RFID tag may include a substrate and an integrated circuit chip. The substrate may include a flexible film such as a polyester (e.g. polyethyleneterephthalate (PET)) for its ball bonding suitability for flip chip attachment of the RFID chip. Other substrates such as a polyamide or epoxy glass (e.g. FR4) are stiffer and thus less suited for reliable ball bonding assembly but are easier to die cut for small tag sizes and may make assembly easier to a plug part associated with the rivet.

The conductor of the primary antenna associated with the RFID tag is preferably aluminium for its low cost and resistance to corrosion, not only in end use but also in a manufacturing process. Other embodiments may include direct application of conductor to the rivet plug part, e.g. via sputtering, vapour deposition or printing, and subsequent bonding of the RFID chip to the conductor.

The RFID tag may be held in place on apart of a rivet such as a plug part with a potting material such as a urethane or epoxy resin which may fully surround the RFID tag for good seal against liquids and steam, and may remain relatively flexible for durable use on the fabric item.

The fabric item to which the rivet is applied may or may not include a hole. In a case where the fabric item includes a hole an assembled rivet may be relatively flat on the surface of the fabric as is preferable for a worn garment. During application of the rivet, the hole may facilitate easy alignment of the primary antenna associated with the RFID tag to the secondary antenna associated with the fabric. The secondary antenna may be formed by stitching a suitable antenna pattern using conductive thread around the hole such that the secondary antenna is flexible and relatively comfortable for a garment wearer.

In a case wherein the fabric item does not include a hole, a version of the rivet may be provided with larger tolerance on the rivet plug part such that an associated snap locking mechanism may accommodate the fabric in the locking mechanism. Although more bulky, this may be more suitable for fabrics such as linen (e.g. in a hotel, hospital, or restaurant), wherein no secondary antenna may be required or a larger secondary antenna (or the region close by the rivet) may be used to compensate for more tolerance on positioning of the RFID tag in the rivet relative to the secondary antenna on the fabric.

According to one aspect of the present invention there is provided an RFID tag assembly including as associated antenna and attachment means suitable for attaching the tag assembly to a material wherein said antenna and said attachment means comprise a unitary conductive frame. The material may be flexible such as fabric or it may be relatively rigid such as cardboard. The associated antenna may include a loop antenna.

The frame may be formed with a plurality of like frames by die stamping from a continuous roll of conductive material. The conductive material may include stainless steel or aluminium.

The attachment means may include a plurality of legs connected to the associated antenna. The free end of each leg may include a sharpened lead to penetrate the material. The tag assembly may include a backing plate for receiving the plurality of legs. The backing plate may include apertures on plural pitch circles to accommodate various thicknesses of material. The tag assembly may include means for short circuiting the associated antenna during assembly at least temporarily.

The material may be flexible and may include a secondary antenna. The tag assembly may be adapted to be attached to the flexible material such that the associated or primary antenna substantially maintains electromagnetic coupling with the secondary antenna when the flexible material flexes in use or is subject to repeated physical manipulation such as may take place during washing cycles.

The present invention may be embodied as a rivet including a tag assembly as described above. The rivet may include an RFID tag. The attachment means may be adapted to attach the rivet to a flexible material such that it may withstand repeated physical manipulation without detaching of the rivet. The flexible material may include fabric or an item of clothing. In some embodiments the secondary antenna may include a conductive thread stitched into the flexible material in the vicinity of the primary antenna.

According to a further aspect of the present invention there is provided a method of producing an RFID tag assembly including an associated antenna and attachment means suitable for attaching the tag assembly to a material including forming the antenna and the attachment means as a unitary conductive frame. The material may be flexible or relatively rigid.

The method may include forming the frame with a plurality of like frames by die stamping from a continuous roll of conductive material. The conductive material may include stainless steel or aluminium. The attachment means may include a plurality of legs connected to the antenna. The method may further include attaching an RFID chip to the antenna on the conductive frame. The method may further include encapsulating the RFID chip and the antenna on the conductive frame.

### BRIEF DESCRIPTION OF THE DRAWINGS

FIG. 1 shows a rivet plug and rivet ring;

FIG. 2 shows an RFID tag including an RFID chip bonded to a conductive track on an insulating substrate;

FIG. 3 shows the RFID tag placed onto the rivet plug;

FIG. 4 shows potting material added to hold and seal the RFID tag in place on the rivet plug to form an RFID rivet plug;

FIG. 5 shows a fabric with a hole around which a secondary antenna is stitched with conductive thread;

FIG. 6 shows the rivet ring placed into the hole in the fabric which facilitates alignment of the rivet to a secondary antenna;

FIG. 7 shows placement of a rivet plug and RFID tag which snap locks to the rivet ring to complete the RFID rivet;

FIGS. 8 to 10 show an alternative embodiment with a one piece rivet plug;

FIGS. 11 to 15 show a further embodiment of an RFID tag assembly with an extended tube section;

FIG. 16 shows a sew-on tag, wherein a primary antenna is held by conductive thread in proximity to a secondary antenna also constructed from conductive thread;

FIG. 17 shows a tag wherein a primary tag package is formed from two halves, one half having a relief slot such that an assembled primary tag package forms a tube through which part of the secondary antenna conductor passes;

FIG. 18 shows a rivet tag wherein a major part containing a primary antenna and an RFID chip is attached to the fabric by pushing metal legs through the fabric and folding the legs over against a minor retaining part;

FIGS. 19A to 19D show a conductive frame of the major part of FIG. 18;

FIG. 20 shows a circular variation of the rivet tag of FIG. 18. which may be further used as an RFID press-stud;

FIG. 21 shows an inline process for producing a conductive frame and associated attachment parts;

FIGS. 22 to 27 show production steps 212 to 217 respectively of the inline process;

FIG. 28 shows an alternative form of loop antenna;

FIG. 29 shows a further form of loop antenna;

FIG. 30 shows an RFID press stud button and a backing plate;

FIGS. 31 to 34 show an RFID press stud button and backing plate being attached to fabric; and

FIG. 35 shows a modified version of the backing plate.

### DETAILED DESCRIPTION OF THE INVENTION

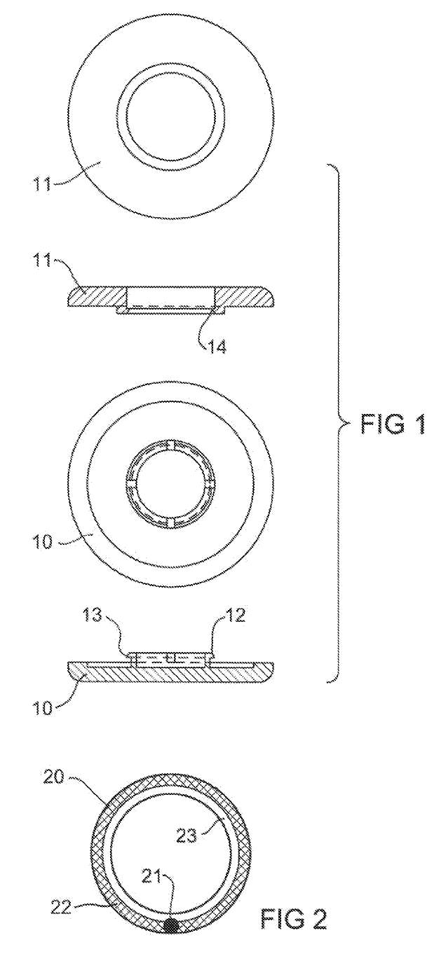

Referring to FIG. 1 an RFID rivet is formed in two parts, a disc part or rivet plug 10 which snap locks into a rectangular toroid part or rivet ring 11. The rivet plug 10 includes a smaller diameter raised tubular part 12 with an external barb 13 which mates to an internal barb recess 14 of a larger diameter raised tubular section of rivet ring 11 to provide a snap locking mechanism.

Referring to FIG. 2, RFID tag 20 includes a primary antenna and RFID chip 21 bonded to a conductive track 22 formed on an insulating substrate 23. Insulating substrate 23 comprises a rectangular toroid shape and may be die cut from a continuous web of complete RFID tags.

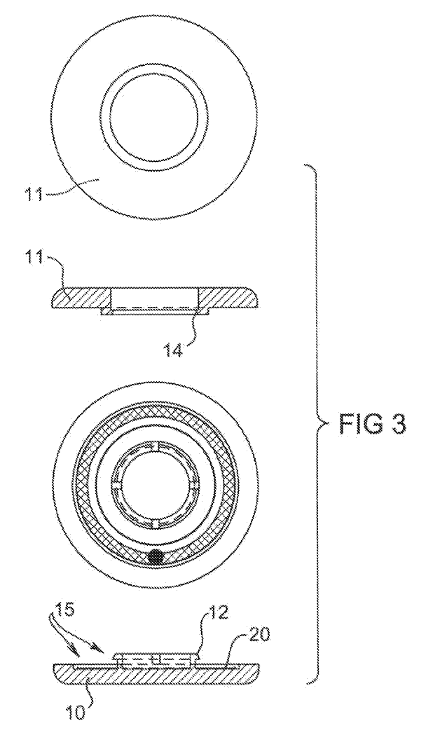

Referring to FIG. 3, RFID tag 20 is placed over the raised tubular part 12 of rivet plug 10 and into an annular recess 15 of rivet plug 10 which is on the same side as raised tubular part 12, the recess 15 having larger outside and smaller inside diameters than the corresponding diameters of RFID tag 20. RFID tag 20 has one flat side facing or contacting the base of recess 15 in rivet plug 10 and the other flat side is exposed. The side of the RFID tag 20 facing the base of recess 15 in rivet plug 10 may have adhesive between itself and the base of recess 15 in rivet plug 10 to hold it in position before a potting step.

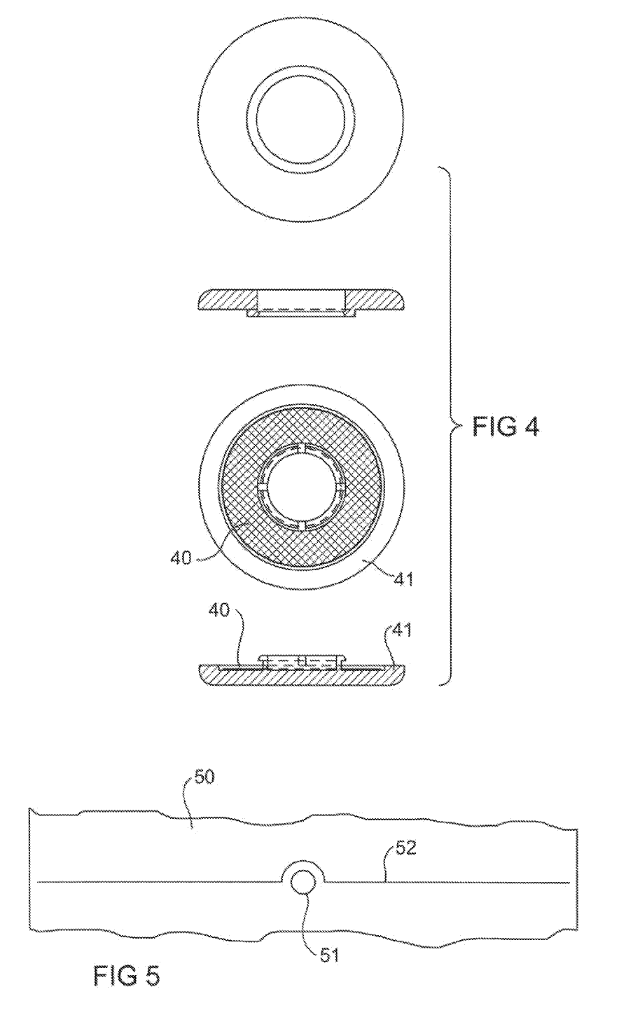

Referring to FIG. 4, potting material 40 is poured into recess 15 of rivet plug 10 and flows to surround RFID tag 20 to hold and seal the RFID tag 20 to rivet plug 10. The potting material 40 at least contacts part of upper regions of outer and inner diameter walls of recess 15 in rivet plug 10 and the exposed flat side of the RFID tag 20 in order to cap recess 15 and seal the RFID tag 20 to form a complete RFID rivet plug 41.

A preferable situation is when potting material 40 contacts all outer and inner diameter walls of recess 15 in rivet plug 10, and hence inner and outer walls of insulating substrate 23 of RFID tag 20, and the exposed flat side of RFID tag 20. This may occur if adhesive is used between RFID tag 20 and rivet plug 10.

A more preferable situation is when potting material 40 contacts all outer and inner diameter walls of recess 15 in rivet pug 10, and hence inner and outer walls of insulating substrate 23 of RFID tag 20, and both the exposed flat side and side facing the base of recess 15 in rivet plug 10 of RFID tag 20. In this situation RFID tag 20 may be totally sealed within potting material 40 and there may be no reliance on a seal created between potting material 40 and walls of recess 15 in rivet plug 10 permitting the rivet to flex more in use, or permitting use of difficult-to-bond materials for the rivet.

Referring to FIGS. 5 to 7, fabric 50 is prepared with hole 51 around which a secondary antenna 52 is stitched with conductive thread. Hole 51 is preferably not button-holed or over-lock stitched to maintain an associated rivet flat or firm against fabric 50. In severe duty use, such as industrial garments, an adhesive may be used between the two halves of a rivet in the region of hole 51 to prevent fraying of fabric 50 when stretched in use.

Embodiments without hole 51 are possible if the diameter of raised tubular section 15 which provides the snap locking mechanism between rivet plug 10 and rivet ring 11 is increased to accommodate fabric 50. Various rivets or at least one of the rivet halves can be made with locking mechanisms adapted or sized to cater for varying fabric thickness. It may be preferable to provide a common complete RFID rivet plug 41 and varying rivet rings 11. In such an arrangement rivet ring 11 may be sized to suit hole 51 to fit common complete RFID rivet plug 41.

Versions of a rivet to be used with a hole may be used on smaller patches of fabric which may be subsequently stitched onto a main fabric item such that the main fabric item is without a hole. The advantages of good RFID tag to secondary antenna alignment and a simple RFID tag assembly may thereby be maintained.

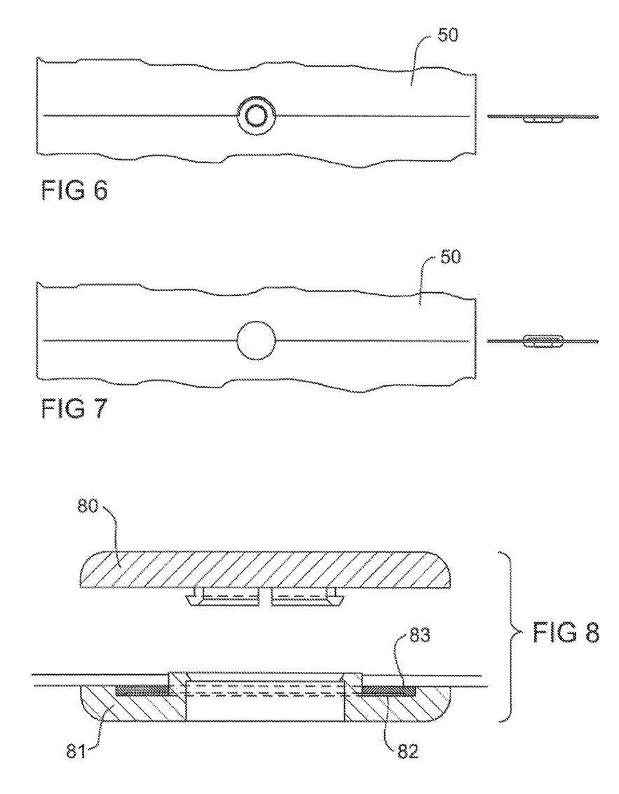

Referring to FIG. 6, raised tubular section 12 of rivet ring 11 fits into hole 51 in fabric 50 which facilitates easily achievable and good alignment of the rivet to secondary antenna 52.

Referring to FIG. 7, a complete RFID rivet plug 41 is pushed into rivet ring 11 such that the respective barbs 13, 14 of the snap locking mechanism hold the complete rivet together. The arrangement may allow relatively good coupling between the primary antenna associated with the RFID tag and the secondary antenna to be maintained when the rivet is knocked about such as in a laundry process.

An alternative embodiment is shown in FIG. 8 wherein a rivet plug 80 is in one piece, which may be simpler to manufacture, and RFID tag assembly 82 is retained in a groove of rivet ring 81 by epoxy 83.

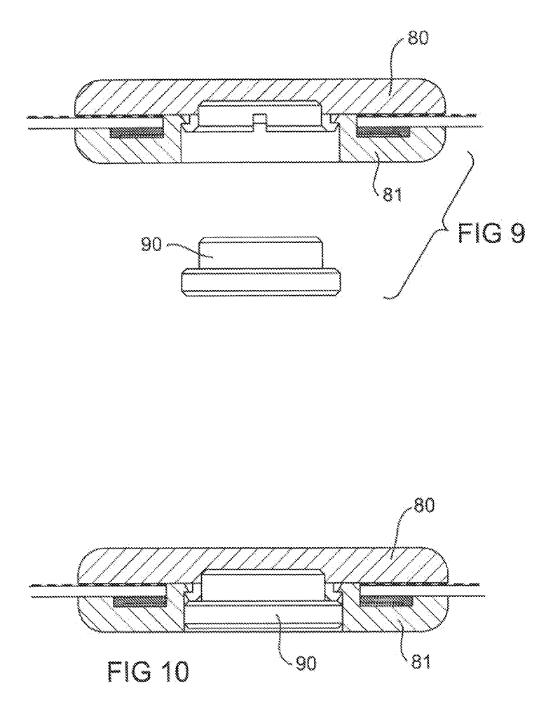

FIG. 9 shows an addition to the alternative embodiment of FIG. 8 wherein a retaining boss 90 is pressed from the outer side of the rivet ring 81 to lock the assembly. FIG. 10 shows the RFID rivet of the alternative embodiment fully locked by retaining boss 90.

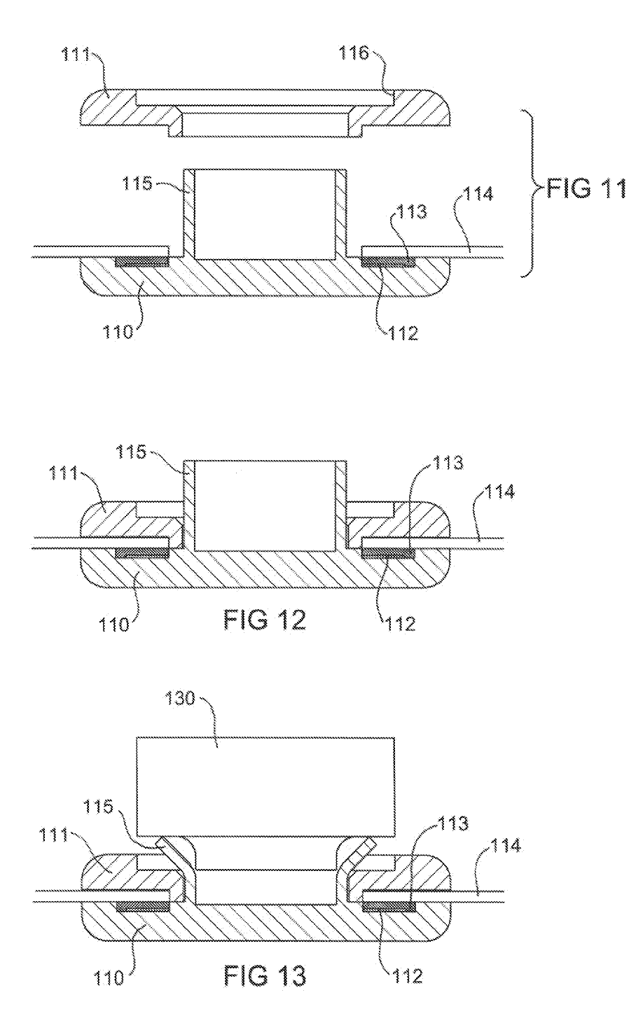

A further embodiment is shown in FIG. 11 wherein a rivet plug 110 contains a RFID tag assembly 112, retained by epoxy 113 in a groove of rivet plug 110. The rivet plug 110 includes an extended tube section 115 which after assembly on fabric 114 is flared into and against a recess 116 on the outer face of rivet ring 111. FIG. 12 shows initial assembly of parts of the embodiment shown in FIG. 11. FIG. 13 shows an early stage of locking the RFID rivet of the embodiment with addition of a heated die 130 which flares the tube section of the rivet plug. The heated die 130 is pressed down against the extended tube section of the rivet plug which flares the extended tube outwards, and the heated die is pressed down until the extended tube section of the rivet plug is fully flared into the recess of the rivet ring.

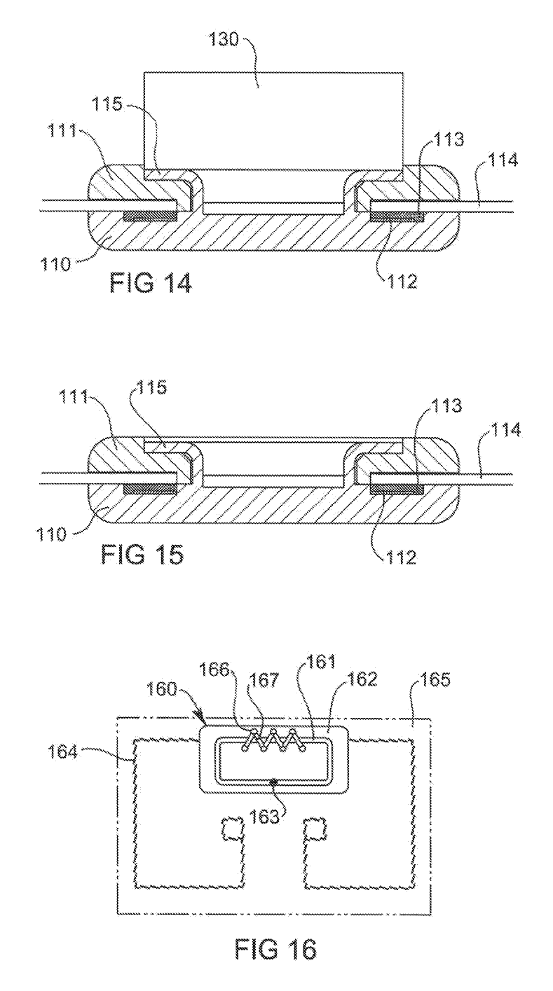

FIG. 14 shows a last stage of locking the RFID rivet of the further embodiment wherein the heated die 130 has fully flared the tube section 115 of the rivet plug 110 into and against recess 116 in rivet ring 111. FIG. 15 shows the RFID rivet of the further embodiment fully seated.

A sew-on embodiment is shown in FIG. 16 wherein RFID tag 160 includes a primary antenna 161 formed by conductor on substrate 162 and RFID chip 163. Tag 160 is held by conductive thread 167 which is sewn through holes 166 in the tag 160 such that tag 160 is held in proximity to secondary antenna 164 also constructed from conductive thread sewn to fabric 165. Alternate embodiments may use a semi-flexible substrate such as polyvinyl chloride (PVC) which may be directly sewn to the fabric without a need for pre-existing holes in the substrate.

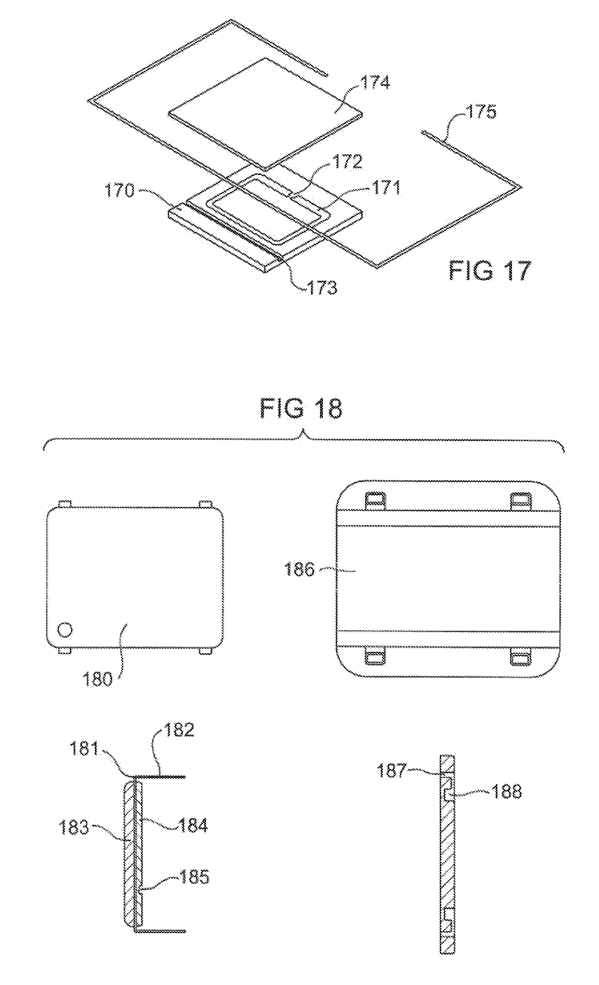

A further sew-on embodiment is shown in FIG. 17 wherein a primary tag package is formed from two halves. A major substrate half 170 with primary antenna conductor 171 and RFID chip 172, may have a relief slot 173 such that when a second minor substrate half 174 is bonded to the major substrate half 170, the assembled primary tag package forms a tube through which part of the secondary antenna conductor 175 passes. The relief slot 173 may alternatively be made on the minor substrate half 170. The secondary antenna conductor 175 is sewn using conductive thread to the base fabric and has a loop section formed by lifting the needle after some stitching and shifting the fabric before resuming stitching to form a loop section of the secondary around which the two primary tag package halves 170, 174 may be assembled. The looping step may be repeated to increase thickness of the secondary antenna conductor in the coupling region, for reasons such as strength or conductivity. The loop may also be in the form of a wick which is sewn across a break in the secondary antenna conductor, or this wick may be already inserted into the tube formed by the two halves of the primary tag package and the assembly stitched across a break in the secondary. The assembled primary tag package may pivot on the secondary antenna which allows fabric surrounding the coupling vicinity to move relative to the primary tag package hence preventing fabric tearing or strain on the thread used to attach the primary tag. This may be the case when the fabric is subjected to bending wherein the fabric surface away from the primary tag has a larger bending radius than the primary tag, and the primary tag being rigid and held only at one edge slips relative to the fabric. Variations in construction may include a paper minor half such as a retail product label with a semi-circular cross sectioned crease as the slot, and a flexible major substrate half which includes an adhesive on one side such that when stuck onto the paper forms a tube wherein a product label may be attached to the product via a tie with a barbed push-together-clasp, wherein at least part of the tie is conductive to form the secondary antenna.

An embodiment of a rivet shown in FIG. 18 is based on dual in-line packaging (DIL packaging or DIP) wherein encapsulating material may be plastics or ceramic for extreme use such as in high temperature and pressure laundry applications. A major part 180 containing a primary antenna which is part of a conductive frame 181 and an RFID chip is sandwiched between a package top half 183 and package bottom half 184. The major part 180 may be attached to the fabric by pushing the part 180 with a top die so that metal legs 182 push through the fabric and through holes 187 in a minor retaining part 186, and folding the legs 182 over against a bottom die with curved slots which positions the minor retaining part 186 against the fabric and directs the ends of the legs 182 into recesses 188 of the minor retaining part 186. Package bottom half 184 may include a recess 185 to provide clearance for the conductive thread. The minor retaining part 186 may be supplied on a reel to match the major part 180 on a separate reel for automated attachment.

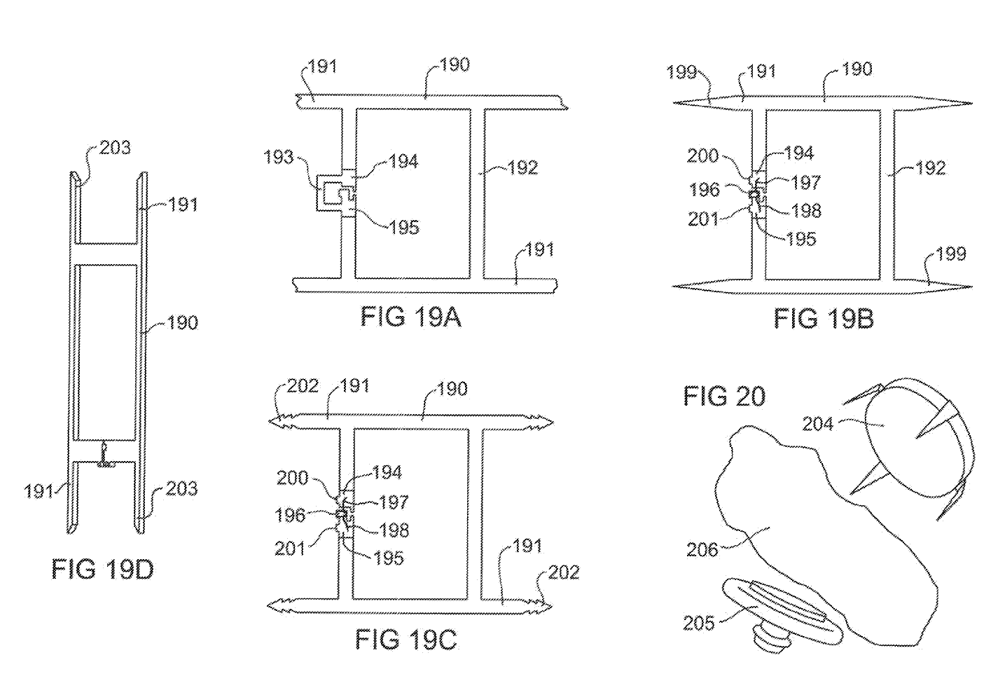

FIGS. 19A and 19B shows a conductive frame 190 which is constructed from metal such as stainless steel, typically by die stamping, in a roll with legs 191 attached to a rectangular loop antenna 192 and to adjacent feeding frames (not shown). A small loop 193, short circuits terminals 194, 195 which are nickel-gold flashed to prepare a surface wherein RFID chip 196 is connected by bond wires 197, 198 or is otherwise connected. Once RFID chip 196 is attached to conductive frame 190, the two halves of the major part packaging may be bonded together sandwiching the conductive frame 190 therebetween with the short circuit loop 193 extending out beyond the packaging of the major part. Alternatively conductive frame 190 and RFID chip 196 may be encapsulated using an injection molding process known as overmolding. The packaged assembly may be left on the roll for automated assembly wherein it may later be die stamped out from the roll. The stamping process may form each leg 191 with a sharp lead in the form of tapered edge 199 and may also remove the short circuit loop 193 leaving small ends 200, 201 as shown in FIG. 19B. The short circuit 193 is desirable during assembly to eliminate static electricity which could otherwise destroy the RFID chip during assembly.

FIG. 19C show an alternative example of a conductive frame 190 including sharpened leads in the form of barbs 202. FIG. 19D shows a further example of a conductive frame 190 including sharpened leads in the form of tapered edges 203. Tapered edges 203 may be similar to the edges formed on the legs of a staple.

Variations of the design may include a circular loop and associated parts for the major part 204 of an RFID tag assembly as shown in FIG. 20. An RFID press-stud button, as shown may be formed using a circular variation of the major part 204 and insulating materials for the minor part 205 of the RFID tag assembly which forms the stud part of the press-stud on the opposite side of material 206.

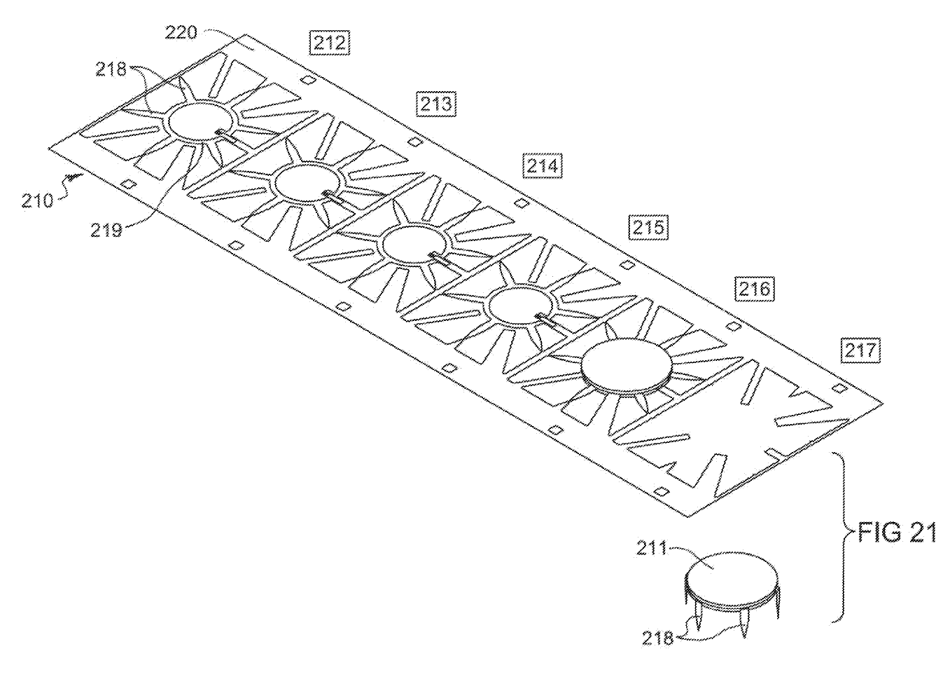

FIG. 21 shows inline steps for producing a conductive frame 210 including associated parts for the major part 211 of the RFID tag assembly as shown in FIG. 21. The production steps include steps 212 to 217 which may be carried out at respective production stations as described below. Conductive frame 210 is constructed from metal such as stainless steel strip, typically by die stamping in a roll with legs 218 attached to circular loop antenna 219 and to peripheral border 220 of conductive frame 210. Loop antenna 219 is short circuited via tracks 221, 222 as described below. In one form conductive frame 210 may be formed from strip material approximately 35 mm wide.

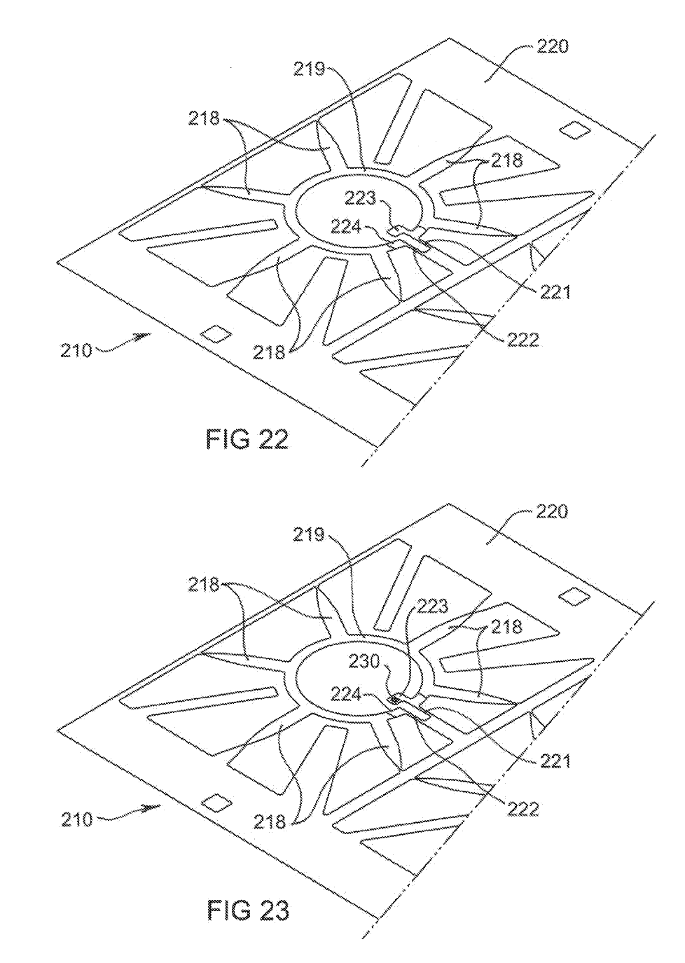

FIG. 22 shows step 212 being carried out at a production station. Step 212 includes terminals 223, 224 being spot nickel gold flash metallized to prepare surfaces wherein an RFID chip is attached at a subsequent station. Terminals 223, 224 are short circuited via tracks 221, 222 which are severed in a subsequent step. The short circuit serves to eliminate static electricity during assembly as described above.

FIG. 23 shows step 213 being carried out at a production station. Step 213 includes depositing a spot of conductive adhesive 230 to terminal 223 for attaching an RFID chip 240 as described below.

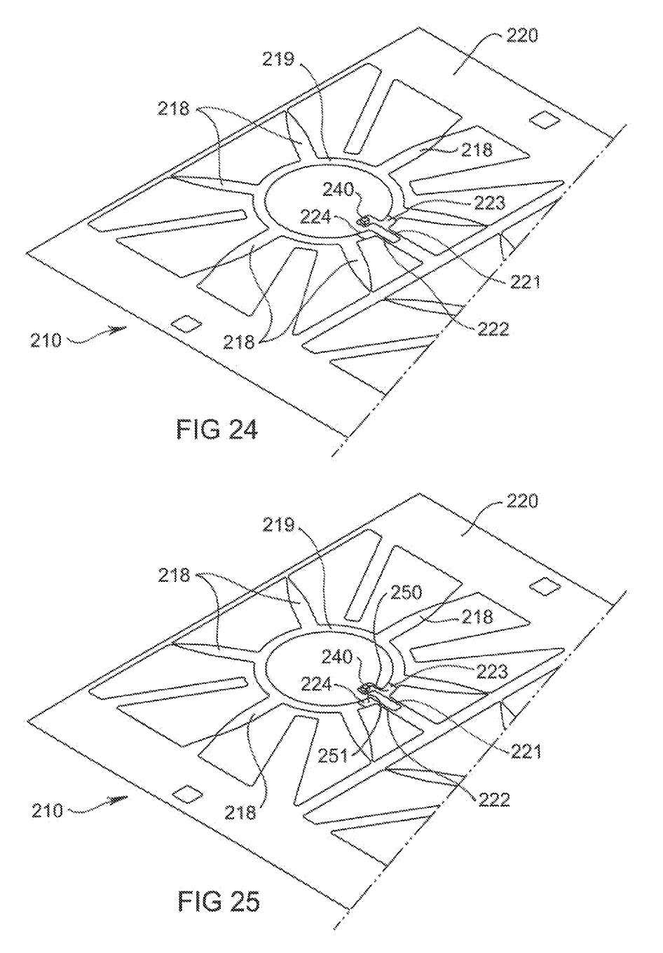

FIG. 24 shows step 214 being carried out at a production station. Step 214 includes attaching RFID chip 240 to terminal 223 of frame 210 via adhesive 230.

FIG. 25 shows step 215 being carried out at a production station. Step 215 includes bonding wires 250, 251 between terminals associated with chip 240 and terminals 223, 224 of conductive frame 210 known as wedge bonding. Alternatively chip 240 may be surface mounted to terminals 223, 224 known as ball bonding (not shown).

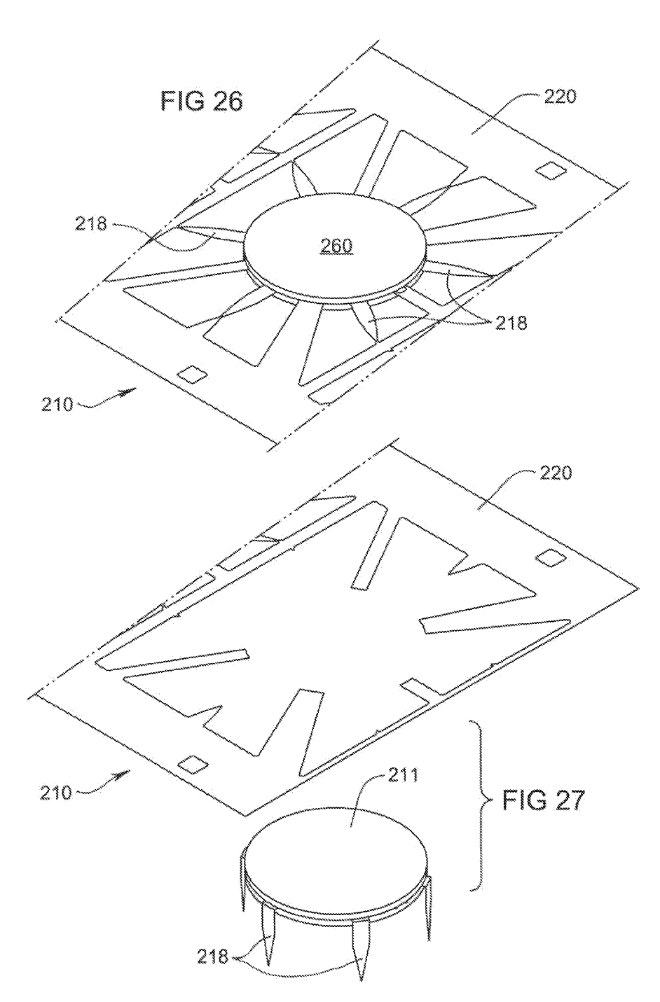

FIG. 26 shows step 216 being carried out at a production station. Step 216 includes encapsulation of antenna loop 219 on frame 210 via plastics packaging 260 using an injection molding process known as overmolding. The complete plastics package may be formed in one piece and in one molding step.

FIG. 27 shows step 217 being carried out at a production station. Step 217 includes severing of encapsulated antenna loop 219 and legs 218 from peripheral border 220. Step 217 also includes severing of tracks 223, 224 to open circuit antenna loop 219 and testing of the assembly. Step 217 may also include turning of legs 218 to form the major part 211.

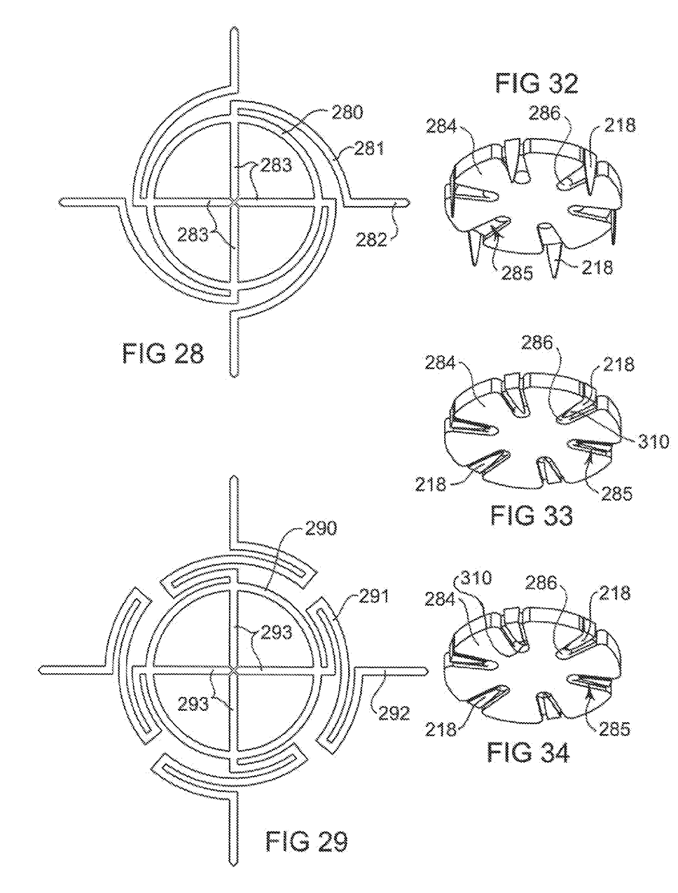

FIG. 28 shows an alternative form of primary loop antenna 280 that may be formed with conductive frame 210 in place of loop antenna 219 shown in FIGS. 21 to 27. Loop antenna 280 is formed with spiral or arc extensions 281 and legs 282 which correspond to legs 191 in the previously described embodiment. However, unlike loop antenna 219 which is open circuit, loop antenna 280 is closed circuit and includes cruciform conductors 283 that are adapted to interface with two ports (two RF inputs) of a modified version of chip 240.

FIG. 29 shows a further form of primary loop antenna 290 that may be formed with conductive frame 210 in place of loop antenna 219 shown in FIGS. 21 to 27. Loop antenna 290 is formed with serpentine extensions 291 and legs 292 which correspond to legs 191 in the previously described embodiment. Loop antenna 291 includes cruciform conductors 293 which perform a similar function to conductors 283 described above.

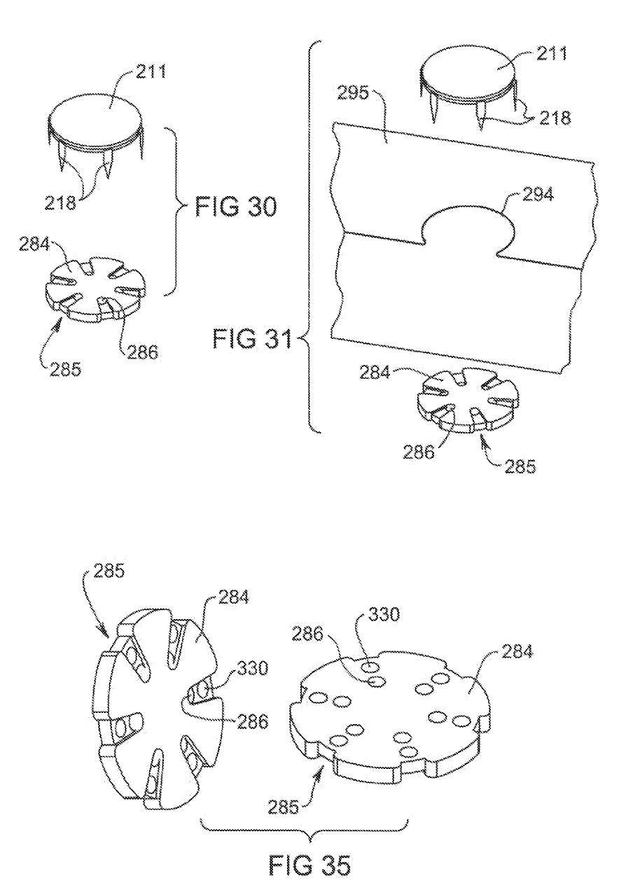

FIG. 30 shows the major part 211 of the RFID tag assembly comprising an RFID press stud button and a minor part 284 comprising a backing plate formed from an insulating material such as plastics. Minor part 284 includes recesses 285 for receiving respective legs 218 and a through aperture 286 located on a circle associated with each recess 285.

FIG. 31 shows the major part 211 positioned above a secondary antenna 294 stitched into fabric 295 with conductive thread. Minor part 284 is positioned under the fabric 295 for mating with major part 211 as described below.

FIG. 32 shows the underside of the fabric 295 after legs 218 of major part 211 have penetrated fabric 295. Minor part 284 is positioned so that each leg 218 is adjacent a respective recess 285 which extends to the underside of minor part 284.

FIG. 33 shows the underside of the fabric 295 after legs 218 are bent towards the centre of minor part 284 so that each leg 218 lies in a respective recess 285 and the tip 310 of each leg 218 over lies a respective aperture 286 in minor part 284.

FIG. 34 shows the underside of the fabric 295 after the tip 310 of each leg 218 is bent into a respective aperture 286 to provide for parts 211 and 284 to be securely held together after repeated washing cycles.

FIG. 35 shows a modified version of minor part 284 including a further set of through apertures 330. The further set of apertures 330 are located on a pitch circle that is larger in diameter relative to the circle on which apertures 286 are located. This is, apertures 330 are spaced further out from the centre of minor part 284 and are adapted to accommodate attachment of parts 211 and 284 to fabric 295 that is proportionately thicker.

Finally, it is to be understood that various alterations, modifications and/or additions may be introduced into the constructions and arrangements of parts previously described without departing from the spirit or ambit of the invention.

1-27. (canceled)

28. An RFID tag assembly comprising:
an associated antenna;
an attachment structure suitable for attaching the tag assembly to a material; and
an RFID chip connected to said antenna;
wherein said antenna and said attachment structure comprise a unitary conductive frame.

29. An RFID tag assembly according to claim 28 wherein said material is flexible.

30. An RFID tag assembly according to claim 28 wherein said associated antenna includes a loop antenna.

31. An RFID tag assembly according to claim 28 wherein said frame is formed with a plurality of like frames by die stamping from a roll of conductive material.

32. An RFID tag assembly according to claim 31 wherein said conductive material includes stainless steel.

33. An RFID tag assembly according to claim 28 wherein said attachment structure includes a plurality of legs connected to said antenna and the free end of each leg includes a sharpened lead to penetrate said material.

34. An RFID tag assembly according to claim 33 including a backing plate for receiving the plurality of legs wherein said backing plate includes apertures on plural pitch circles to accommodate various thicknesses of said material.

35. An RFID tag assembly according to claim 28 including means for short circuiting said antenna during assembly at least temporarily.

36. An RFID tag assembly according to claim 29 wherein said flexible material includes a secondary antenna and wherein said attachment structure is adapted to attach said associated antenna to said flexible material such that said associated antenna substantially maintains electromagnetic coupling with said secondary antenna when said flexible material flexes in use or is subject to repeated physical manipulation such as may take place during washing cycles.

37. A tag assembly according to claim 29 wherein said flexible material includes fabric or an item of clothing.

38. A tag assembly according to claim 36 wherein said secondary antenna includes a conductive thread stitched into said flexible material.

39. A rivet including a tag assembly according to claim 28 wherein said attachment structure is adapted to attach said rivet to said material.

40. A method of producing an RFID tag assembly including an associated antenna and attachment structure suitable for attaching the tag assembly to a material, said method including the steps of forming said antenna and said attachment structure as a unitary conductive frame and attaching an RFID chip to said associated antenna on said conductive frame.

41. A method according to claim 40 wherein said material is flexible.

42. A method according to claim 40 wherein said associated antenna includes a loop antenna.

43. A method according to claim 40 including forming said frame with a plurality of like frames by die stamping from a roll of conductive material.

44. A method according to claim 43 wherein said conductive material includes stainless steel.

45. A method according to claim 40 including forming the attachment structure as a plurality of legs connected to said primary antenna and forming the free end of each leg with a sharpened lead to penetrate said material.

46. A method according to claim 40 including short circuiting said associated antenna during assembly at least temporarily.

47. A method according to claim 40 including encapsulating said RFID chip and said associated antenna on said conductive frame.
